(19) United States
(12) Patent Application Publication
(10) Pub. No.: US 2019/0049558 A1
(43) Pub. Date: Feb. 14, 2019

(54) Hand Gesture Recognition System and Method

(71) Applicant: KC Sense Limited, Shatin (HK)

(72) Inventors: Ling Sing Yung, Tusen Wan (HK); Wing Kei Wong, Shatin (HK); Hok Cheung Shum, Tin Shui Wai (HK)

(73) Assignee: KC Sense Limited

(21) Appl. No.: 15/671,196

(22) Filed: Aug. 8, 2017

(51) Int. Cl. G01S 7/41; G01S 13/52; G06F 3/01

(52) U.S. Cl. CPC G01S 7/412; G01S 13/88; G06F 3/017; G01S 13/52

(57) ABSTRACT

A hand gesture recognition system is disclosed as including a radar transceiver (14) adapted to transmit radar signals and receive reflected radar signals, a machine-readable memory stored with data representing a plurality of waveforms of reflected radar signals, each waveform of reflected radar signals representing one of three pre-defined hand gestures, a gesture recognition unit (20) adapted to compare waveforms of reflected radar signals received by the radar transceiver with the data stored in the machine-readable memory and to thereby determine the hand gesture represented by the received reflected radar signals, and a visual display unit adapted to display graphics in response to the hand gesture determined by the gesture recognition unit.

This invention relates to a hand gesture recognition system and method, in particular, such a system and method of recognizing the hand gesture of a user by radar.

### BACKGROUND OF THE INVENTION

Virtual reality (VR) is a computer technology that uses virtual reality headsets/goggles to generate realistic images, sounds and other sensations that simulate a user's physical presence in a virtual or imaginary environment. A person using virtual reality equipment can “look around” the artificial world (virtual reality) and interact with virtual features or items in the virtual reality. VR headsets are head-mounted goggles with a screen in front of the eyes of the wearer.

More advanced VR systems allow a user to interact with the VR world, in which the VR systems receive input from the user and in turn provide consequential feedback to the user in response to the input. In such VR systems allowing input by the user, sometimes a hand-held controller is provided whereby the user may input instructions to the system by pressing one or more buttons on the controller, which are transmitted via data lines or by moving the controller before a sensor which senses signals transmitted by the controller. In the former arrangement, the wires may become tangled during or after use, and may thus hamper use of the controller. In the latter arrangement, signals (e.g. infrared signals) transmitted by the controller may not be received or well received by the sensor, e.g. because the controller and the sensor are out of line-of-sight with each other, or because of other environmental factors.

There have thus been proposals to detect hand gestures of a user and determine the specific instructions intended by the user by using radar signals. An advantage of using radar signals is that it is more reliable and stable. However, most existing radar-based hand gesture recognition system are designed to recognize a relatively large number of different hand gestures. This would hamper the performance of the entire system.

It is thus an object of the present invention to provide a system and a method of hand gesture recognition in which the aforesaid shortcomings are mitigated or at least to provide a useful alternative to the trade and public.

### SUMMARY OF THE INVENTION

According to a first aspect of the present invention, there is provided a hand gesture recognition system including a radar transceiver adapted to transmit radar signals and receive reflected radar signals, a machine-readable memory stored with data representing a plurality of waveforms of reflected radar signals, each said waveform of reflected radar signals representing one of three pre-defined hand gestures, a gesture recognition unit adapted to compare waveforms of reflected radar signals received by the radar transceiver with the data stored in said machine-readable memory and to thereby determine the hand gesture represented by the received reflected radar signals, and a visual display unit adapted to display graphics in response to the hand gesture determined by the gesture recognition unit.

According to a second aspect of the present invention, there is provided a hand gesture recognition method including storing data representing a plurality of waveforms of reflected radar signals, each said waveform of reflected radar signals representing one of three pre-defined hand gestures, transmitting radar signals towards a hand of a user, receiving radar signals reflected from the hand of the user, comparing waveforms of the received reflected radar signals with the stored data and thereby determining the hand gesture represented by the received reflected radar signals, and visually displaying graphics in response to the determined hand gesture.

### BRIEF DESCRIPTION OF THE DRAWINGS

An embodiment of the present invention will now be described, by way of example only, with reference to the accompanying drawings, in which:

FIG. 1 shows a schematic diagram of a hand gesture recognition system according to an embodiment of an invention according to the present invention;

FIG. 2 shows a swiping movement of a hand;

FIG. 3 shows an upward pulling movement of a hand;

FIG. 4 shows a clicking movement of a finger of a hand;

FIG. 5 is a flowchart showing a process of effecting machine-learning of the hand gesture recognition system of FIG. 1;

FIG. 6 is an exemplary waveform of reflected radar signals of a swiping movement of a hand;

FIG. 7 is an exemplary waveform of reflected radar signals of an upward pulling movement of a hand;

FIG. 8 is an exemplary waveform of reflected radar signals of a clicking movement of a finger of a hand;

FIG. 9 is a flowchart showing steps of operation of the hand gesture recognition system of FIG. 1.

### DETAILED DESCRIPTION OF THE EMBODIMENT

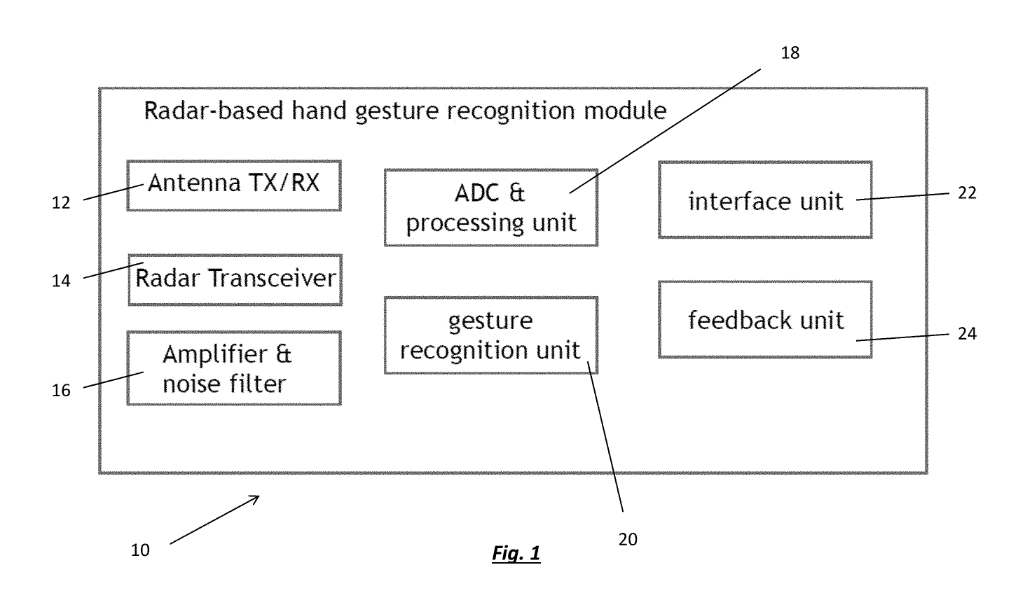

A radar-based hand gesture recognition module of a hand gesture recognition system according to an embodiment of an invention according to the present invention is shown in FIG. 1 and generally designated as (10). The module (10) includes an antenna (12), e.g. a 24 GHz antenna, for transmitting radar signals and receiving reflected radar signals. The antenna (12) is connected with a radar transceiver unit (14) adapted to generate radar signals to be transmitted by the antenna (12) and to receive the reflected radar signals received by the antenna (12). The antenna (12) is designed to cover a range of 50-80 cm with a field of view of 120°. The range and field of view can cover most user hand gesture movements. In addition, by limiting the range and field of view, unwanted signals due to other motions or unrelated object movement can be filtered out. The radar transceiver (14) is used as an RF front-end part.

An amplifier and noise filter unit (16) is connected with the radar transceiver (14) for adjusting the balance between noise figure, linearity and power gain, thereby achieving the best performance. A signal conversion and processing unit (18) with a data processing unit integrated with analog-digital converter (ADC) (such as an ARM Cortex M4 series chip with integrated ADC) is used for acquiring analog signals from the front-end part. Signals generated by Doppler effects are captured by the radar transceiver (14), converted by the ADC in the unit (18) and transferred to the data processing unit in the signal conversion and processing unit (18) for processing.

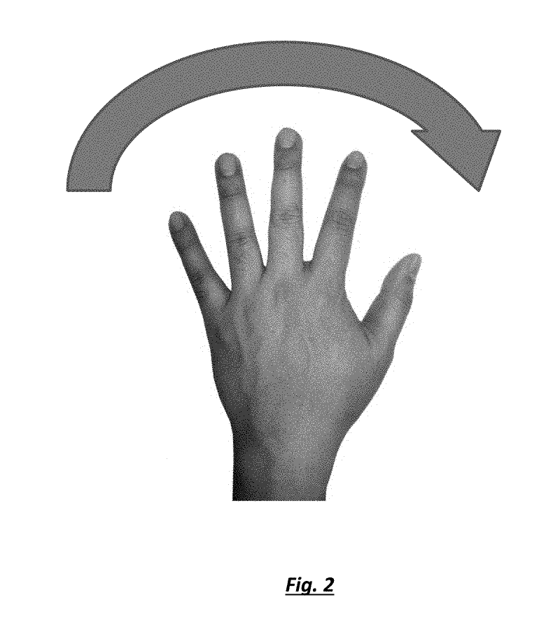

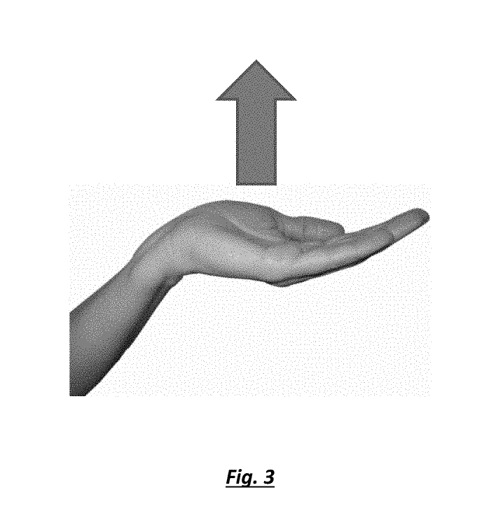

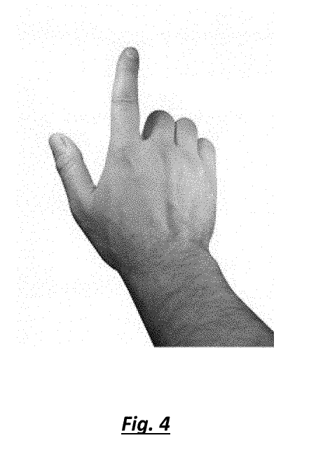

The module (10) also includes a non-transitory machine-readable memory in which data representing a number of waveforms of reflected radar signals are stored. The machine-readable memory is connected with the signal conversion and processing unit (18) and a gesture recognition unit (20) (to be discussed below). Each waveform of reflected radar signals represents one of three pre-defined hand gestures, namely a swiping movement of a hand (as shown in FIG. 2, and defined as a hand swinging from right to left across the radar antenna (12) within a distance of 80 cm), a generally upward pulling movement of a hand (as shown in FIG. 3, and defined as a hand pulling up from bottom to up across the radar antenna (12) within a distance of 80 cm), and a clicking movement of a finger of a hand (as shown in FIG. 4, and defined as a hand tipping a point with a finger and within a distance of 80 cm from the antenna (12)). Taking swiping movements of a hand as an example, each swiping movement of a hand may be different. Thus, a number of waveforms representing different swiping movements of a hand are collected and the relevant data stored in the machine-readable memory. For example, the relevant frequency and time delay information of the waveforms of the reflected radar signals may be extracted from the waveforms for comparison and identification purposes. It is known that the waveforms of the reflected radar signals of the above three pre-defined hand gestures differ from one another at least in terms of frequency and time delay.

The gesture recognition unit (20) of the module (10) compares data representing waveforms of the reflected radar signals generated by Doppler effects caused by movement of a hand, as captured by the radar transceiver (14), converted by the ADC in the signal configuration and processing unit (18) and transferred to the data processing unit in the signal configuration and processing unit (18) with data representing waveforms of each of the three pre-defined hand gestures (e.g. frequency and time delay information) stored in the machine-readable memory of the module (10), and determines what the waveforms of the reflected radar signals represent.

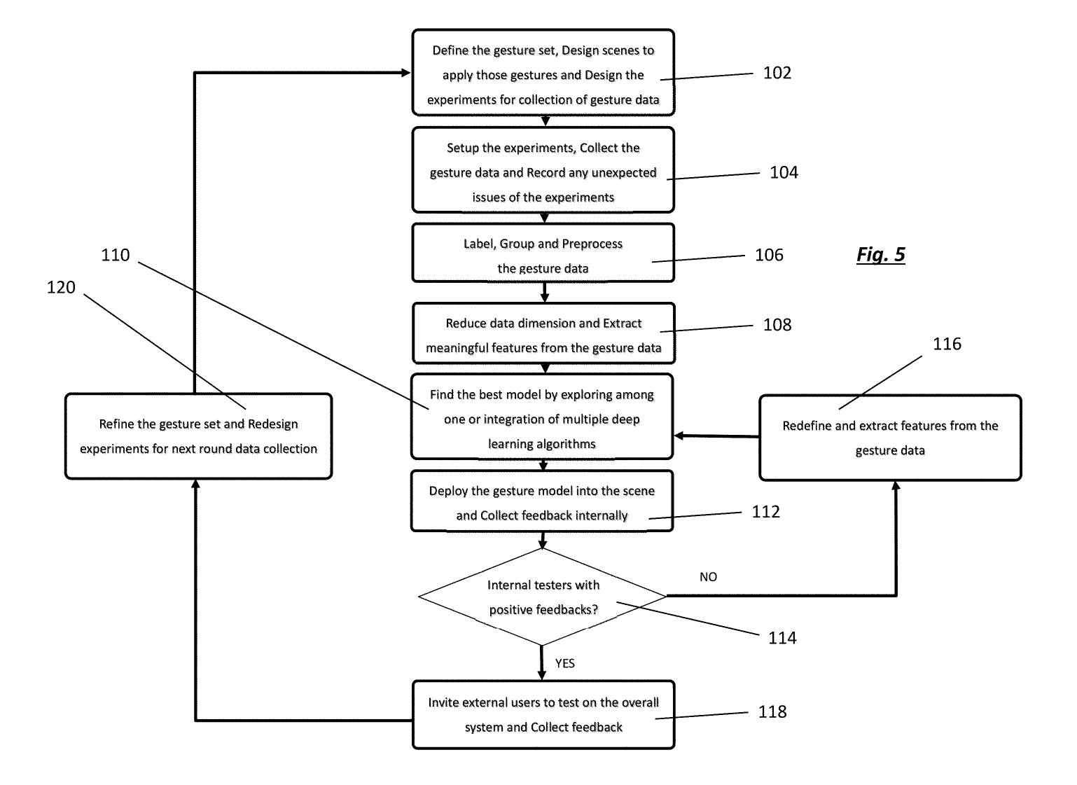

FIG. 5 is a flowchart showing a process of effecting machine-learning of the hand gesture recognition system according to an embodiment of the present invention. The process starts by defining the gesture set, designing scenes to apply those gestures and designing experiments for collection of gesture data (102). In the present invention it is decided that only three pre-defined hand gestures are to be recognized, namely a swiping movement of a hand, a generally upward pulling movement of a hand, and a clicking movement of a finger of a hand. Subsequently, the experiments are set up, the hand gesture data are collected, and any unexpected issues of the experiments are recorded (104). The hand gesture data are then labeled, group and processed (106). The data dimension are reduced and meaningful features are extracted from the hand gesture data (108). The best model is found by exploring among one or an integration of multiple deep learning algorithms (110). The gesture model is deployed into the scene and feedback is collected internally (112). One then assesses whether there are positive feedbacks from internal testers (114). If no, features from the hand gesture data are redefined and extracted (116), and then the best model is again found by exploring among one or integration of multiple deep learning algorithms (110). If there are positive feedbacks from internal testers (114), external testers then test on the overall system and their feedback collected (118). The hand gesture set are then re-defined and experiments are re-designed for subsequent rounds of data collection (120).

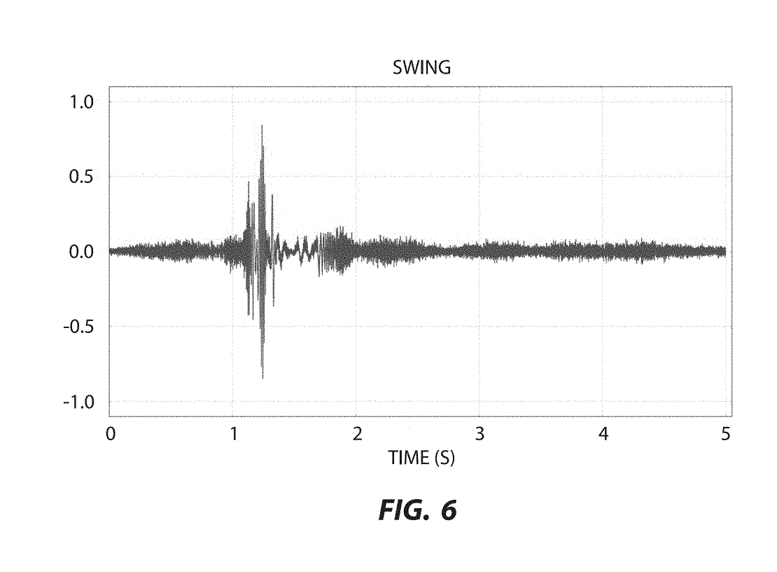

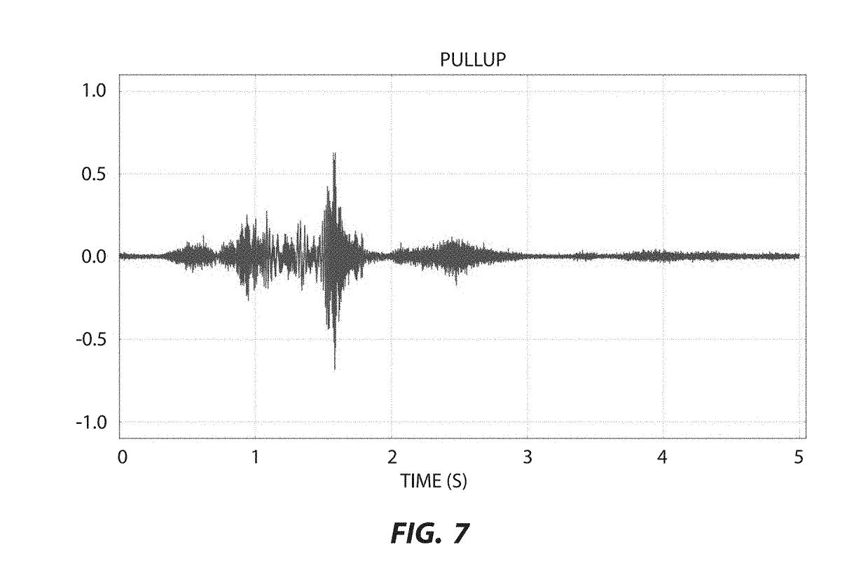

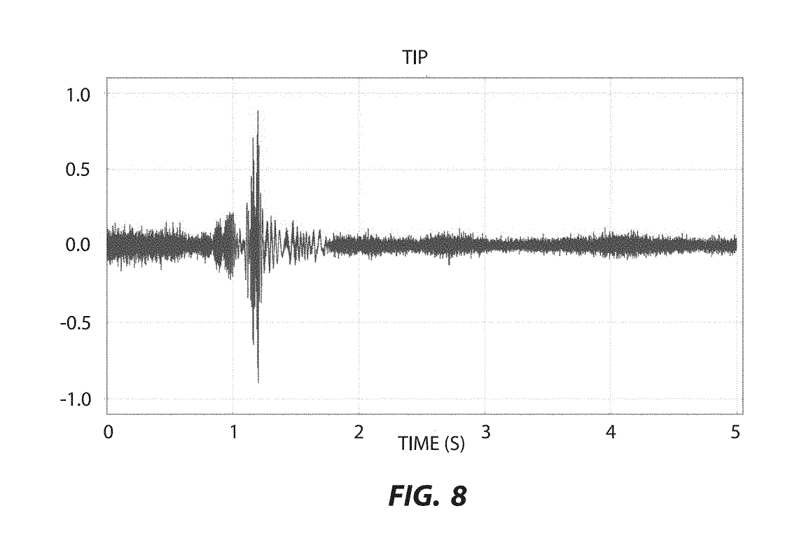

FIG. 6 is an exemplary waveform of reflected radar signals of a swiping movement of a hand. FIG. 7 is an exemplary waveform of reflected radar signals of an upward pulling movement of a hand. FIG. 8 is an exemplary waveform of reflected radar signals of a clicking movement of a finger of a hand.

Returning to FIG. 1, once the gesture recognition unit (20), after carrying out comparison, determines what hand gesture the received reflected radar signals represent, it sends the result via an interface unit (22) of the module (10) to a feedback unit (24) for producing the appropriate feedback to the user. For example, the feedback unit (24) may cause a visual display unit to display graphics viewable by a user wearing a VR headset to which the module (10) is installed.

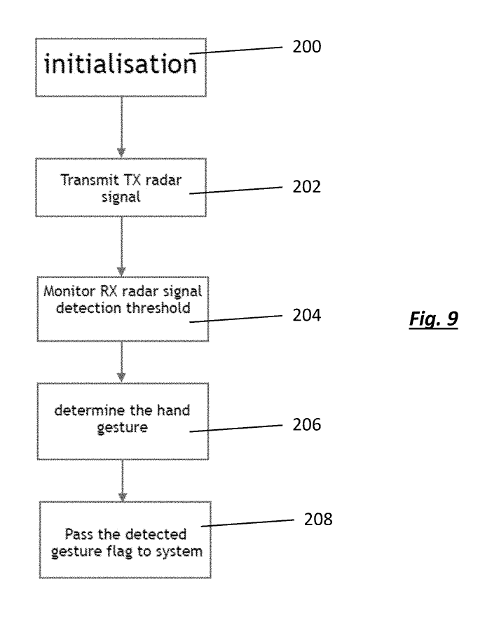

FIG. 9 is a flowchart showing steps of operation of the hand gesture recognition system. After initialization (200), the radar transceiver (14) of the module (10) generates radar signals to be transmitted by the antenna (12) (202). The radar transceiver (14) then monitors whether any received reflected radar signals are above the detection threshold (204). If so, the received reflected radar signals are processed by the signal conversion and processing unit (18), and then transferred to the gesture recognition unit (20) for determining the hand gesture represented by the received reflected radar signals (206). The determined hand gesture is then passed to the interface unit (22) of the system (208) for identifying the appropriate response corresponding to the determined hand gesture, and the response is then carried out by the feedback unit (24).

In an exemplary VR system adopting the hand gesture recognition system and method according to an embodiment of the present invention, the swiping movement of a hand may be defined as an action to move forward or to switch between applications; a pulling up movement of a hand may be defined as an action to bring up a menu or cancel/discard a menu; and a clicking movement of a finger of a hand may be defined as an action to select or highlight certain specific objects in the VR environment.

It is found that, as compared with infrared-based solutions, the radar-based system and method according to the present invention have the following advantages:
(a) Since infrared (IR) detection depends on the ambient temperature and environment, many environmental factors (such as ambient light sources and IR remote controls) can corrupt the detection results. In contrast, radar system deploys electromagnetic (EM) waves at a frequency of 24 GHz, which is a relatively stable means. In addition, by limiting the detection range to 80 cm away from the radar antenna (12), background noises and interferences are significantly reduced.
(b) As IR sensing requires capturing images by IR cameras, any physical blockage would hamper detection. On the other hand, as radar detection employs EM waves which have high penetration power, the above shortcoming can be mitigated.
(c) Technically, IR-based solutions require much more calculation in order to estimate the position of the hand. On the other hand, radar-based solutions conduct simpler calculations to probe the position and movement of the hand, which translates into less use of battery power, and thus longer battery life.
(d) On board radar antenna and fully integrated radar front-end enable small form factor radar solution. As compared with IR camera, radar sensors can be fully integrated in main board printed circuit board. This greatly enhances product design flexibility.

As discussed above, the system and method are designed such that only three hand gestures are pre-defined and thus to be recognized. Of course, pre-defining more types of hand gestures to be recognized could increase the control flexibility of the system. This would however degrade the response time and accuracy for determining the hand gesture in question. There is thus an inevitable trade-off between the number of pre-defined hand gestures and the recognition performance. In particular:
(a) The three hand gestures pre-defined according to the present system and method are simple and intuitive. Complex and numerous gestures are difficult to memorize, thus degrading user experience.
(b) Increasing the number of hand gestures will increase the complexity of the algorithm, and thus the response time. A long response time is not conducive to smooth transition and control of the system by the user.
(c) Limiting the number of pre-defined hand gestures to three would also enhance detection accuracy.

The hand gesture recognition system and method according to the present invention can be implemented in a VR system for use in gaming, workspace and music platforms. Switching between different platforms and basic manipulations of the system and method are implemented by the three hand gestures, possibly with the addition of detection of the head orientation.

Referring back to FIG. 1, the signal conversion and processing unit 18 and the gesture recognition unit 20 may each be embodied as hardware. The memory may be separate from the signal conversion and processing unit 18 and the gesture recognition unit 20 or may be distributed within both. On the other hand, the signal conversion and processing unit 18 may be embodied in whole or in part as hardware and the gesture recognition unit 20 may be embodied as software stored in memory. In that case, a memory may either be separate from the signal conversion and processing unit 18 or located therein and in any event the gesture recognition unit 20 may be stored in the memory.

Referring back to FIG. 9, it shows an example of a method, according to an embodiment, carried out on an exemplary apparatus such as but not limited to the module 10 of FIG. 1. The apparatus may include at least one signal processor that includes at least one central processing unit (CPU) and at least one memory device including a computer program that executes, at least in part, the steps shown in the embodiment of FIG. 9. In other words, the program comprises steps such as shown in whole or in part in FIG. 9. Those steps may be expressed as a combination of computer instructions and data definitions that enable a computer such as the above mentioned central processing unit to perform acts of computation or control. Thus, such instructions may take the form of software. Such software is sometimes referred to as comprising computer program code that likewise comprises computer instructions and data definitions expressed in a programming language or in a form output by an assembler, compiler, or other translator. Software comprising computer program code is thus able, together with at least one central processing unit, to cause an apparatus at least to carry out certain steps such as outlined in whole or in part in FIG. 9 or FIG. 5. The method steps shown herein may be coded by a computer programmer so as to express the method steps in a programming language. In an exemplary embodiment, the apparatus may be a portable electronic VR display device such as a head mounted display. Such a portable electronic device is carried by a user as the user moves in a VR environment and is moreover typically used to present the user with the VR, before the face of the user for comfortable viewing. The VR device may include a display, circuitry and a battery in a single unit. It may come equipped with sensors, e.g., including cameras, a microphone, one or more accelerometers, head position and attitude sensors, and a GPS receiver. On-screen features may include a pop-up touchscreen keyboard for typing with the pointing feature of FIG. 4 that allows the user to navigate easily and type with a virtual keyboard on the screen. The headgear has a certain translatory (translational) position (in three degrees of freedom) and attitude (three degrees of freedom) as it moves through three dimensional VR space in all six degrees of freedom with respect to a reference coordinate system such as a VR coordinate system.

It should be understood that the above only illustrates an example whereby the present invention may be carried out, and that various modifications and/or alterations may be made thereto without departing from the spirit of the invention. It should also be understood that various features of the invention which are, for brevity, described here in the context of a single embodiment, may also be provided separately or in any appropriate sub-combinations.

1. A hand gesture recognition system including:
a radar transceiver adapted to transmit radar signals and receive reflected radar signals,
a machine-readable memory stored with data representing a plurality of waveforms of reflected radar signals, each said waveform of reflected radar signals representing one of three pre-defined hand gestures,
a gesture recognition unit adapted to compare waveforms of reflected radar signals received by the radar transceiver with the data stored in said machine-readable memory and to thereby determine the hand gesture represented by the received reflected radar signals, and
a visual display unit adapted to display graphics in response to the hand gesture determined by the gesture recognition unit.

2. The system of claim 1, wherein the three pre-defined hand gestures include a swiping movement of a hand, a generally upward pulling movement of a hand, and a clicking movement of a finger of a hand.

3. The system of claim 1, wherein the visual display unit is comprised in a headset wearable by a user.

4. The system of claim 1, wherein the radar transceiver is comprised in a headset wearable by a user.

5. The system of claim 1, wherein the system is comprised in a virtual reality system.

6. A hand gesture recognition method including:
storing data representing a plurality of waveforms of reflected radar signals, each said waveform of reflected radar signals representing one of three pre-defined hand gestures,
transmitting radar signals towards a hand of a user,
receiving radar signals reflected from the hand of the user,
comparing waveforms of the received reflected radar signals with the stored data and thereby determining the hand gesture represented by the received reflected radar signals, and
visually displaying graphics in response to the determined hand gesture.

7. The method of claim 6, wherein the three pre-defined hand gestures include a swiping movement of a hand, a generally upward pulling movement of a hand, and a clicking movement of a finger of a hand.

8. The method of claim 6, wherein the graphics is visually displayed in a visual display unit.

9. The method of claim 8, wherein the visual display unit is comprised in a headset wearable by a user.

10. The method of claim 6, wherein the data representing a plurality of waveforms of reflected radar signals are stored in a machine-readable memory.
